(19) United States
(12) Patent Application Publication
(10) Pub. No.: US 2009/0234981 A1
(43) Pub. Date: Sep. 17, 2009

(54) RECEIVING APPARATUS, TRANSMISSION/RECEPTION SYSTEM AND DEVICE CONTROL METHOD

(75) Inventors: Toshiyuki Umeda, Inagi-shi (JP); Makoto Tsuruta, Kawasaki-shi (JP); Shoji Otaka, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/331,895

(22) Filed: Dec. 10, 2008

(30) Foreign Application Priority Data
Mar. 17, 2008 (JP) 2008-067767

(51) Int. Cl. G06F 3/00

(52) U.S. Cl. 710/18

(57) ABSTRACT

A receiving apparatus includes: a receiving unit receiving a set of a plurality of signals in which at least a part of transfer rates is different during a certain period of time; a rate detecting unit detecting a plurality of transfer rates of the plurality of signals; a first obtaining unit obtaining first information based on the plurality of transfer rates; a second obtaining unit obtaining second information based on the plurality of signals; and a control signal generating unit generating a control signal based on the first and second information.

### CROSS-REFERENCE TO RELATED APPLICATIONS

This application is based upon and claims the benefit of priority from the prior Japanese Patent Application No. 2008-067767, filed on Mar. 17, 2008; the entire contents of which are incorporated herein by reference.

### BACKGROUND OF THE INVENTION

1. Field of the Invention

The present invention relates to a receiving apparatus, a transmission/reception system and a device control method receiving a radio signal for controlling a device.

2. Description of the Related Art

When controlling a plurality of devices with signals from one remote controller (hereinafter, refer to as “remocon”), there is a possibility of generating errors in control due to an arrangement of devices or the like. For instance, if devices A and B are arranged on a straight line seen from the remote controller, the device B may receive a signal for controlling the device A, resulting that it may falsely operate. Note that there is disclosed a technique in which a position of remocon is detected and a device to be an object to be controlled is specified based on the position and a position of the device, to thereby control the device using signals including an ID of the device (refer to JP-A 2004-166193 (KOKAI)).

### BRIEF SUMMARY OF THE INVENTION

In the above-described technique, it is required to set positional information on devices and to detect the position of the remocon. For this reason, it becomes necessary to reset the positional information on devices each time the devices are moved or a room is redecorated.

An object of the present invention is to provide a receiving apparatus, a transmission/reception system and a device control method having an improved reliability of controlling devices.

A receiving apparatus according to one aspect of the present invention includes: a receiving unit receiving a set of a plurality of signals in which at least a part of transfer rates is different; a rate detecting unit detecting a plurality of transfer rates of the plurality of signals; a first obtaining unit obtaining first information based on the plurality of transfer rates; a second obtaining unit obtaining second information based on the plurality of signals; and a control signal generating unit generating a control signal controlling a device based on the first and second information.

A transmission/reception system according to one aspect of the present invention includes the aforementioned receiving apparatus and a transmitting apparatus transmitting the above-described set of signals.

A device control method according to one aspect of the present invention includes: receiving a set of a plurality of signals in which at least a part of transfer rates is different; detecting a plurality of transfer rates of the plurality of signals; obtaining first information based on the plurality of transfer rates; obtaining second information based on the plurality of signals; and generating a control signal controlling a device based on the first and second information.

### BRIEF DESCRIPTION OF THE DRAWINGS

FIGS. 1A and 1B are schematic diagrams in which a conventional information transfer method and an information transfer method according to an embodiment of the present invention are compared with each other.

FIG. 2 is a block diagram representing a control system 100 according to a first embodiment of the present invention.

FIG. 3 is a circuit diagram showing one structural example of a rectifying unit 132 shown in FIG. 2.

FIG. 4 is a timing chart representing a demodulated signal output from the rectifying unit 132.

FIGS. 5(a) and 5(b) are timing charts representing signals at a rate detecting unit 133.

FIG. 6 is a graph representing a power spectrum of the demodulated signal or a received signal.

FIG. 7 is a flowchart representing one example of operating procedures of the control system 100.

FIG. 8 is a flowchart representing one example of operating procedures of the control system 100.

FIG. 9 is a block diagram representing a control system 200 according to a second embodiment of the present invention.

FIG. 10 is a flowchart representing one example of operating procedures of the control system 200.

### DESCRIPTION OF THE EMBODIMENTS

Concepts of embodiments herein below will be explained. In the embodiments hereinbelow, a device is controlled by transferring a set of a plurality of signals in which at least a part of transfer rates is different. Specifically, control information is transferred by varying the transfer rate (baud rate). For instance, the control information is handled as information which transfers values of transfer rates or a difference in the values. As a result of this, it becomes possible to control the device using two main and sub transfer channels. The information through the main transfer channel is represented by a signal itself (for instance, an amplitude of signal (H/L)). The information through the sub transfer channel is represented by a transfer rate (or a difference in transfer rates). Through each of the main channel and the sub channel, a command controlling the device and an ID (Identification) of the device, for instance, can be transferred in parallel. As such, by transferring the control information using the two transfer channels, reliability and confidentiality when controlling the device can be improved.

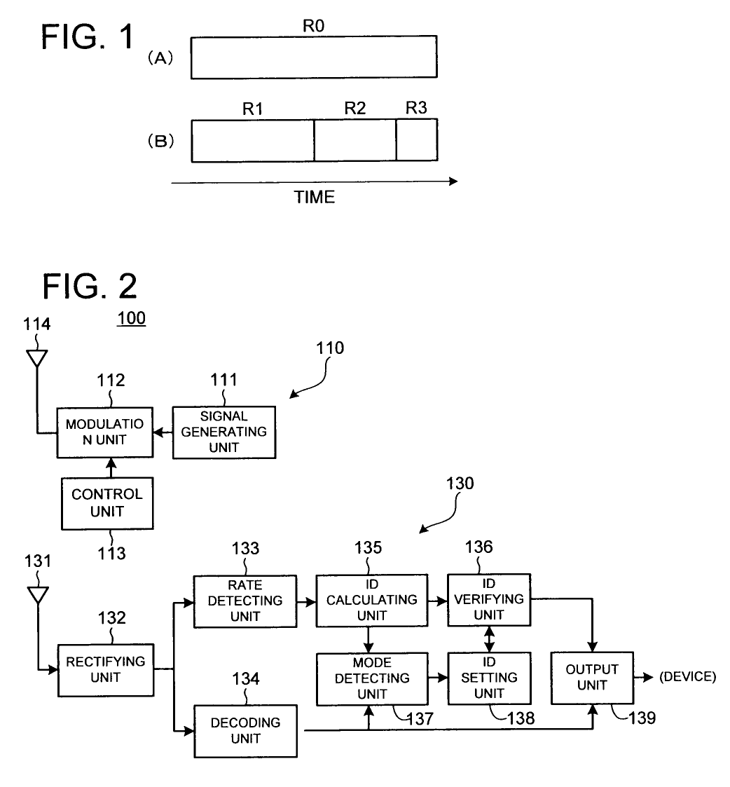

FIGS. 1A and 1B are schematic diagrams in which a conventional information transfer method and an information transfer method according to an embodiment of the present invention are compared with each other. FIGS. 1(A) and 1(B) respectively represent a signal transferred in a conventional embodiment and a signal transferred in the present embodiment. Note that a horizontal axis indicates time. In the conventional embodiment, a transfer rate is constant, and a device is controlled by a signal of a transfer rate R0. On the other hand, in the present embodiment, transfer rates are switched, and the device is controlled by a set of signals of transfer rates R1, R2 and R3. Here, the set of signals indicates a plurality of signals which are transferred continuously or with a predetermined time interval therebetween during a predetermined period of time. Specifically, in an example of FIG. 1(B), a signal of transfer rate R1, a signal of transfer rate R2 and a signal of transfer rate R3 are collectively referred to as the set of signals of the transfer rates R1, R2 and R3. The signals of the transfer rates R1, R2 and R3 can be transferred in a continuous manner as shown in FIG. 1(B) or can be transferred by leaving a predetermined time interval therebetween.

Hereinafter, embodiments of the present invention will be explained in detail.

### First Embodiment

FIG. 2 is a block diagram representing a control system 100 according to a first embodiment of the present invention. The control system 100 includes a transmitting apparatus 110 transmitting/receiving signals of electromagnetic waves such as radio waves or light, and a receiving apparatus 130.

The transmitting apparatus 110 is, for example, a portable transmission terminal, and functions as a so-called remocon which controls a device. The transmitting apparatus 110 includes a signal generating unit 111, a modulation unit 112, a control unit 113 and an antenna 114, and transmits a set of a plurality of signals in which at least a part of transfer rates is different, as shown in FIG. 1(B). The signal generating unit 11 generates a predetermined basic signal (RF signal, for instance). The modulation unit 112 modulates the basic signal output from the signal generating unit 111. The control unit 113 controls the modulation unit 112, to thereby modulate the signal and switch the transfer rates.

The receiving apparatus 130 receives the signal to generate a command and a trigger signal, and outputs them to the device. The command is a signal for controlling the device. The trigger signal is a signal for shifting a state of the device (shift from a dormant state to an active state (power supply ON), for instance). The receiving apparatus 130 includes an antenna 131, a rectifying unit 132, a rate detecting unit 133, a decoding unit 134, an ID calculating unit 135, an ID verifying unit 136, a mode detecting unit 137, an ID setting unit 138 and an output unit 139.

The antenna 131 receives the signal transmitted from the transmitting apparatus 110.

The rectifying unit 132 includes a power generating part in which power is generated by the signal received by the antenna 131, and a demodulation part obtaining a demodulated signal from the signal. By the electric power supplied from the rectifying unit 132, the rate detecting unit 133, the decoding unit 134, the ID calculating unit 135, the ID verifying unit 136, the mode detecting unit 137 and the ID setting unit 138 are driven. For this reason, the receiving apparatus 130 can be operated in low power consumption.

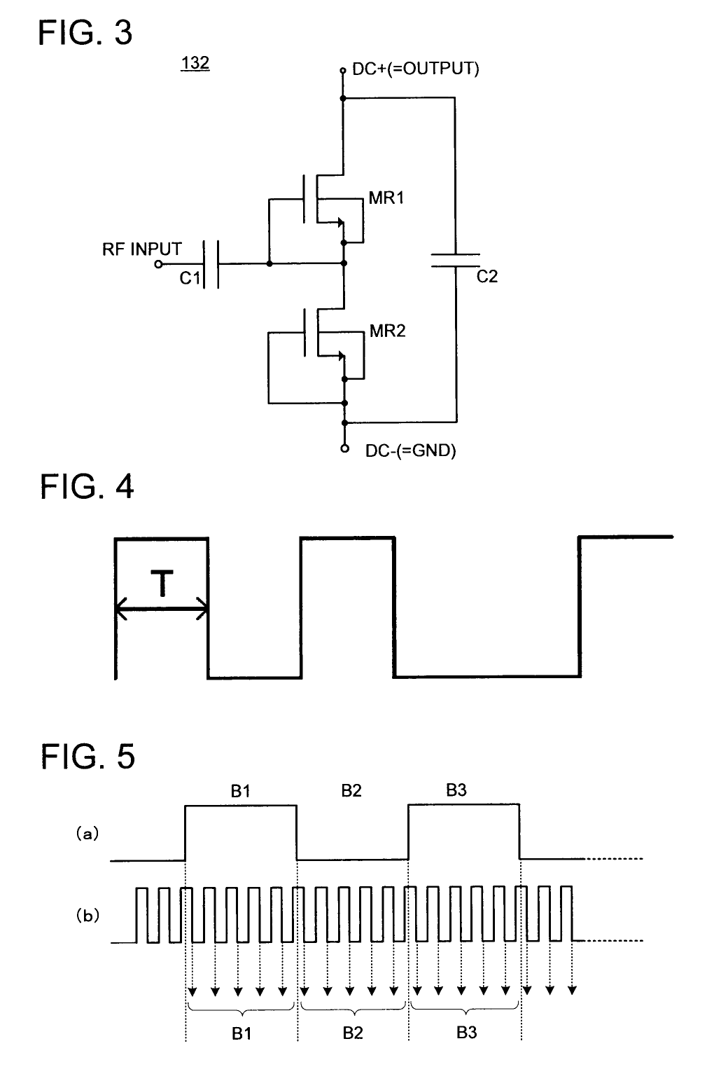

FIG. 3 shows one structural example of the rectifying unit 132 shown in FIG. 2. The rectifying unit 132 includes nMOS type transistors MR1 and MR2 connected in series. Gates and sources of the transistors MR1 and MR2 are short-circuit-connected, respectively (specifically, the transistors MR1 and MR2 are connected by a type of diode connection). A capacitor C1 is connected to a wiring which connects the transistors MR1 and MR2, and the RF signal is input from the antenna 131. Further, a smoothing capacitor C2 connected between a drain of the transistor MR1 and the source of the transistor MR2 generates an output voltage (rectified voltage).

When the RF signal is input, a half-wave current is flown through a path of the transistor MR1, the capacitor C2 and the transistor MR2. As a result of this, direct current output voltages (rectified voltages) are generated at both ends of the capacitor C2. A lower terminal DC− of the rectifying unit 132 shown in FIG. 3 is connected to a ground. An upper terminal DC+ of the rectifying unit 132 shown in FIG. 3 is connected, as an output terminal of the rectifying unit 132, to the rate detecting unit 133 and the decoding unit 134.

The rate detecting unit 133 detects a transfer rate (concretely, a baud rate) of the demodulated signal output from the rectifying unit 132. Next, a detection method of the transfer rate will be described. Hereinafter, two detection methods will be described, and either of the detection methods can be applied. Further, there is no problem if other methods are applied to the detection of the transfer rate.

(1) A first rate detection method will be explained. The demodulated signal output from the rectifying unit 132 is represented in FIG. 4. A time interval T from a rising edge to a falling edge of the demodulated signal is measured to thereby estimate the transfer rate. For example, the time interval T is measured at a plurality of times, and the transfer rate is calculated on the assumption that the measured minimum time interval T corresponds to the transfer rate.

Here, when a signal format is set so that the demodulated signal includes a fixed pattern (specific bit string) (when there is a preamble for estimating the baud rate), it is possible to estimate the transfer rate (baud rate) by one time of the measurement.

Hereinafter, details regarding the above will be described. Here, the rate detecting unit 133 is supposed to have an oscillating part (not shown) which generates clock signals. Further, an oscillation frequency of this oscillating part (not shown) is supposed to be larger than the baud rate to be detected. This is because the time interval T is measured by the clock signals.

FIGS. 5(a) and 5(b) are timing charts representing signals at the rate detecting unit 133. FIG. 5(a) shows an example of the demodulated signals. FIG. 5(b) shows an example of the clock signals output from the oscillating part of the rate detecting unit 133. Here, first three bits B1 through B3 of the specific bit string are set as 1, 0 and 1, as shown in FIG. 5(a). The rate detecting unit 133 counts the clock signals in the oscillating part from a rising edge to a falling edge of the first bit B1, and holds its result. Here, a count number n1 is 5, as shown in FIG. 5(b).

When the rate detecting unit 133 detects the next bit B2, the counting of clock signals in the oscillating part is started again, and the counting is continued until a rising edge of the next bit B3 is detected. Here, a count number n2 is 5.

The rate detecting unit 133 compares the count number n1 with the count number n2, and it determines, when the n1 is not less than (n2−a) nor more than (n2+a), the transfer rate is detected (a: error). Here, n1=5 and n2=5, so that the rate detecting unit 133 determines that the transfer rate is detected, and calculates a transfer rate R using, for instance, the following formulas.

R=1/(n0*T)

n0=(n1+n2)/2

n0: count number of clock signals per one symbol (one bit, in this example)
τ: time per one clock

The rate detecting unit 133 detects the transfer rate each time it receives the signal. As a result of this, the transfer rates R1, R2 and R3 are detected in this order, for example.

(2) A second rate detection method will be described. Here, the transfer rate is estimated from a power spectrum of the demodulated signal output from the rectifying unit 132 or of the received signal output from the antenna 131.

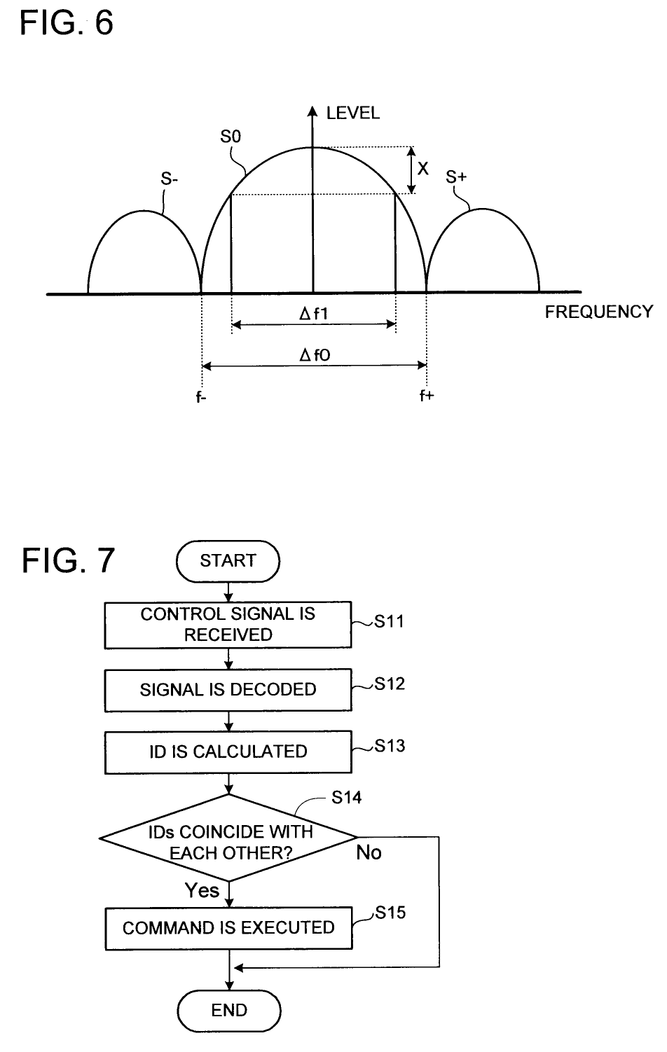

FIG. 6 is a graph representing the power spectrum of these signals. The power spectrum shown in FIG. 6 includes a main lobe S0 and side lobes S− and S+. When a frequency is changed so that it is increased or reduced with a maximum level of the main lobe S0 as a center, there are frequencies f+ and f− corresponding to a minimum level of the main lobe S0. An inverse number (1/Δf0) of an interval Δf0 between the two frequencies f+ and f− is an estimated value of the transfer rate R.

The baud rate can be estimated without searching the minimum level of the main lobe S0. It is possible to estimate the baud rate from a frequency width Δf1 at a point where the frequency is lowered by a predetermined value (X[dB]) from the maximum level of the main lobe S0 of the power spectrum. A shape of the power spectrum is determined by a signal to be transmitted. Specifically, there is a relation of Δf0=α*Δf1 between the frequency width Δf1 and the frequency interval Δf0. If a coefficient α is determined, the baud rate can be estimated by calculating the frequency interval Δf0 from the frequency width Δf1. The coefficient α can be stored in the rate detecting unit 133 as a lookup table or the like.

The decoding unit 134 performs a decoding processing on the demodulated signal based on rate information obtained in the rate detecting unit 133, to thereby obtain a decoded signal (decoded information and data portion). Concretely, data regarding High/Low (1/0) of the demodulated signal is collected at a timing corresponding to the transfer rate R detected by the rate detecting unit 133. The decoded signal can be used as a control command and control data of a rear stage device. The decoding unit 134 functions as a second obtaining unit obtaining second information based on the plurality of signals.

Hereinafter, a concrete example of an operation of the decoding unit 134 will be shown based on FIGS. 5(a) and 5(b). The decoding unit 134 collects data from the demodulated signal at a timing of each counter number of n0 (here, each five count). With respect to the bit B3, by setting its rising edge as a reference, the demodulated signal is collected at a timing of counter number of n0/2 (after three counts). Thereafter, the decoding unit 134 continues to collect data at a timing of counter number of n1 (here, each five count). The data collection is continued until the number of data bits reaches a predetermined number or a code indicating the end of data is received.

Note that the operational contents of the decoding unit 134 may be appropriately changed depending on a form of the signal to be transferred.

The ID calculating unit 135 obtains ID information from the transfer rate R detected in the rate detecting unit 133 (obtainment of rate portion). The ID calculating unit 135 functions as a first obtaining unit obtaining first information based on the plurality of transfer rates. Here, a concrete obtaining method of the ID information when the transfer rates R1, R2 and R3 are obtained will be explained. Note that in the following calculations, only integral parts are used and fractions below decimal point are rounded down.

(1) In the first method, a difference in the transfer rates is regarded as information. For example, when a reference rate and a rate resolution are respectively set as R1 and ΔR, an amount of information to be transferred is represented by log₂|R2−R1|/ΔR[bit] and log₂|R3−R1|/ΔR[bit]. At this time, numeric values A1=|R2−R1|/ΔR and Δ2=|R3−R1|/ΔR themselves can be regarded as transfer information. Further, it is also possible to convert these numeric values A1 and A2 into the transfer information by referring to the lookup table.

These numeric values A1 and A2 can be respectively handled as ID information. In this case, the numeric values A1 and A2 may be the same value and may indicate the same ID information. Further, the numeric values A1 and A2 may be different values and may indicate different pieces of ID information. Furthermore, the numeric values A1 and A2 can be combined together and handled as one ID information. Here, a case is assumed where the ID information is obtained as information in which the numeric values A1 and A2 are combined together. For example, the numeric values A1 and A2 are disposed in this order on a high-order bit side and a low-order bit side. Alternatively, an opposite pattern thereof can also be conceivable. The ID information is obtained as described above.

(2) In the second method, the transfer rates themselves are regarded as information. An amount of information to be transferred is represented by log₂(R1/ΔR) [bit], log₂(R2/ΔR) [bit], and log₂(R3/ΔR)[bit]. At this time, numeric values B1=R1/ΔR, B2=R2/ΔR, and B3=R3/ΔR themselves can be regarded as transfer information. Alternatively, it is also possible to convert these numeric values B1 through B3 into the transfer information by referring to the lookup table. The numeric values B1 through B3 can be handled independently or by combining them together.

The ID verifying unit 136 compares the ID information obtained in the ID calculating unit 135 with an original ID previously stored in the ID setting unit 138 and outputs its result to the output unit 139. If these IDs coincide with each other, a command corresponding to the decoded signal is output from the output unit 139 to the rear stage device. If the IDs do not coincide with each other, the output of the command from the output unit 139 to the device is not conducted.

The mode detecting unit 137 compares the ID information calculated in the ID calculating unit 135 with the decoded information decoded in the decoding unit 134. When the ID information and the decoded information coincide with each other, the ID information and information indicating coincidence are output to the ID setting unit 138. Here, the coincidence between the ID information and the decoded information is supposed to indicate a shift into an ID changing mode in which an ID can be changed. In the ID changing mode, IDs held in the ID setting unit 138 can be changed.

The ID setting unit 138 holds one or a plurality of ID(s). When the ID setting unit 138 holds the plurality of IDs, it holds information indicating which ID among the plurality of IDs is the original ID. In preparation for changing the ID of device, the ID setting unit 138 holds the plurality of IDs. Among them, an ID used for controlling the device is the original ID. In the ID changing mode, the ID setting unit 138 changes the original ID. Specifically, the ID setting unit 138 functions as a changing unit changing an identification of device.

When the ID verifying unit 136 determines that the IDs coincide with each other, the output unit 139 outputs the command corresponding to the decoded signal. For example, the ID verifying unit 136 outputs a trigger signal for turning on the power supply to the device. As a result of this, a state of device changes from a dormant state to an active state, and electric power is supplied to the entire of the device. The output unit 139 functions as a control signal generating unit generating a control signal controlling the device based on the first and second information.

### (Operation of Control System 100)

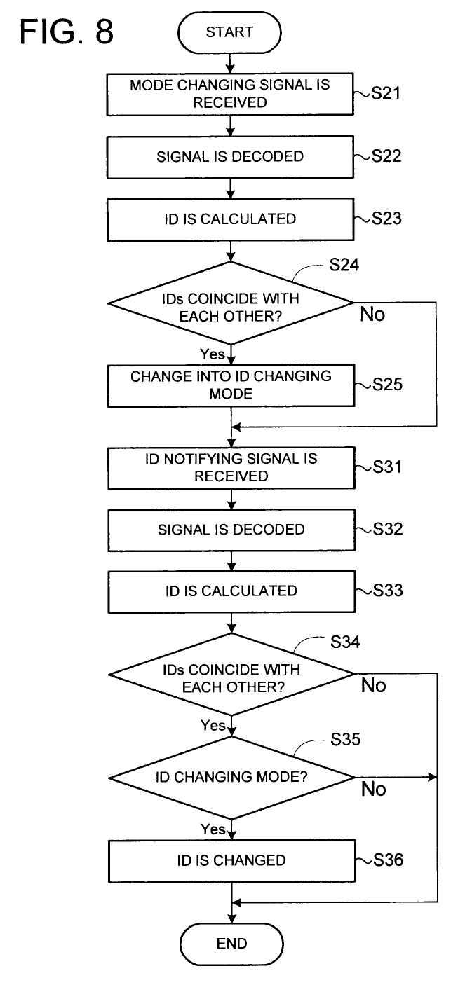

Hereinafter, an operation of the control system 100 will be described. FIG. 7 and FIG. 8 are flowcharts representing an example of operating procedures of the control system 100. FIG. 7 and FIG. 8 respectively illustrate a control of device and a change of ID.

### A. Control of Device

The control signal for controlling device is transmitted from the transmitting apparatus 110 and is received by the receiving apparatus 130 (step S11). A rate portion (ID information) and a data portion (decoded information) of the control signal respectively represent the original ID and a control command (control data) of the device.

Here, when the control signal is represented by a set of signals of the transfer rates R1, R2 and R3, for instance, the same command can be corresponded to each data portion of the signals of the transfer rates R1, R2 and R3. In this case, it is possible to reduce a malfunction of device due to an error in transfer, by using a majority decision.

Note that when both the rate portion and the data portion of the signal represent the original ID, the signal corresponds to a later-described mode changing signal.

The control signal is demodulated in the rectifying unit 132, to thereby generate the demodulated signal. A data portion (demodulated information) is obtained from the demodulated signal by the decoding unit 134 (step S12). Meanwhile, a rate portion (ID information) is obtained from the demodulated signal by the rate detecting unit 133 and the ID calculating unit 135 (step S13). Note that these steps S12 and S13 are simultaneously executed in parallel.

It is determined whether or not the rate portion (ID calculated by the ID calculating unit 135 (ID transmitted by radio wave)) coincides with the ID held in the ID setting unit 138 (step S14). If these IDs coincide with each other, a command is output to the device. For example, the device in a dormant state is activated (power supply ON) (step S15). If these IDs do not coincide with each other, the control command (control data) is discarded as invalid, and the device is not controlled.

As described above, when the same command is corresponded to each data portion of the signals of the transfer rates R1, R2 and R3, for instance, the majority decision can be applied. Specifically, when the commands represented by these data portions do not completely coincide with each other, the command at the majority side is output to the device. As a result of this, the malfunction of device due to an error in transfer can be reduced.

### B. Change of ID

A case is assumed where the ID of device is changed. By changing the ID of device held in the receiving apparatus 130, it is possible to enhance a security and to eliminate a chance of overlap of IDs. Here, the ID of device is changed using the mode changing signal and an ID notifying signal.

### (1) Change of Mode

The mode changing signal for setting the receiving apparatus 130 to the ID changing mode is transmitted from the transmitting apparatus 110 and is received by the receiving apparatus 130 (step S21). Here, in the mode changing signal, both a rate portion (ID information) and a data portion (decoded information) are supposed to represent the original ID. The data portion (decoded information) and the rate portion (ID information) are obtained by the decoding unit 134 and the ID calculating unit 135, respectively (steps S22 and S23).

It is determined whether or not the both rate portion (ID information) and the data portion (decoded information) coincide with the ID held in the ID setting unit 138 (step S24). Specifically, if the three IDs coincide with one another, the receiving apparatus 130 is set to the ID changing mode (step S25).

The above point will be more specifically described. The mode detecting unit 137 checks whether or not the rate portion (ID information) coincides with the data portion (decoded information), and outputs its result (first result information) to the ID setting unit 138. Meanwhile, the ID verifying unit 136 compares the rate portion (ID information) obtained in the ID calculating unit 135 with the original ID previously stored in the ID setting unit 138, and outputs its result (second result information) to the ID setting unit 138. If both the first and second result information indicate coincidence, information indicating the ID changing mode is held in the ID setting unit 138.

In the above description, both the rate portion (ID information) and the data portion (decoded information) of the mode changing signal coincide with the original ID. Instead of this, it is also possible to set a signal in which a command representing a mode change is indicated in a data portion (decoded information) as the mode changing signal. In this case, only the rate portion (ID information) coincides with the original ID. Since a processing at this time is not fundamentally different from one in a case where both the rate portion (ID information) and the data portion (decoded information) coincide with the original ID, a detailed explanation thereof will be omitted.

### (2) Notification of ID

The ID notifying signal for notifying the receiving apparatus 130 of the changed ID is transmitted from the transmitting apparatus 110 and is received by the receiving apparatus 130 (step S31). Here, in the ID notifying signal, both a rate portion (ID information) and a data portion (decoded information) are supposed to represent the changed ID. The data portion (decoded information) and the rate portion (ID information) are obtained by the decoding unit 134 and the ID calculating unit 135, respectively (steps S32 and S33).

It is determined whether or not both the rate portion (ID information) and the data portion (decoded information) coincide with the ID held in the ID setting unit 138 (step S34). As a result of this, if the three IDs coincide with one another, and the receiving apparatus 130 is in the ID changing mode (step S35), the original ID held in the ID setting unit 138 is changed (step S36).

In the above description, both the rate portion (ID information) and the data portion (decoded information) of the ID notifying signal coincide with the changed ID. Instead of this, it is also possible to set a signal in which a command representing an ID notification is indicated in a data portion (decoded information) as the ID notifying signal. In this case, only the rate portion (ID information) coincides with the original ID. Since a processing at this time is not fundamentally different from one in a case where both the rate portion (ID information) and the data portion (decoded information) coincide with the changed ID, a detailed explanation thereof will be omitted.

According to the present embodiment, it is possible to obtain two independent transfer channels by transferring a set of a plurality of signals in which at least a part of transfer rates is different. By using these two transfer channels, reliability and confidentiality when controlling a device can be improved.

### (1) Improvement of Reliability

The ID of device can be changed by a signal from a side of remocon (side of transmitting apparatus 110). As a result of this, the malfunction of device can be reduced. Specifically, it is possible to reduce the malfunction of device due to an overlap of IDs or the like. Note that by using two transfer channels, the ID of device can be changed with a short code length.

By making the transfer rates of signal variable, it becomes easy to identify each signal, which enables to reduce the malfunction of device. Further, when the same information is corresponded to each data portion of a plurality of signals, it is possible to improve an error rate with the use of majority decision. It should be noted that different pieces of information can be corresponded to each data portion of the plurality of signals.

### (2) Improvement of Confidentiality

The ID of device can be changed by a signal from a side of remocon (side of transmitting apparatus 110). As a result of this, it becomes easy to secure confidentiality of the ID of device against a threat from the outside.

### Second Embodiment

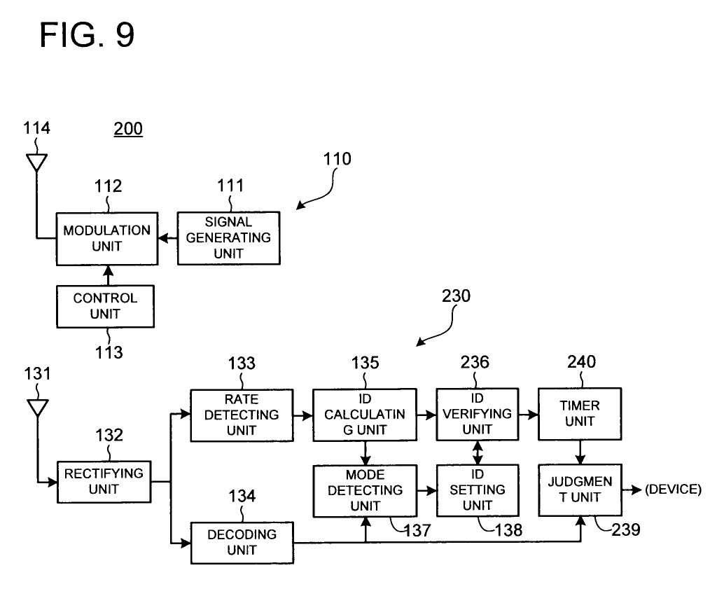

A second embodiment of the present invention will be described. FIG. 9 is a block diagram representing a control system 200 according to the second embodiment of the present invention. A receiving apparatus 230 includes the antenna 131, the rectifying unit 132, the rate detecting unit 133, the decoding unit 134, the ID calculating unit 135, an ID verifying unit 236, the mode detecting unit 137, the ID setting unit 138, a judgment unit 239 and a timer unit 240. Note that the components substantially the same as those in the control system 100 are given the same reference numerals and detailed explanations thereof will be omitted.

The ID verifying unit 236 compares ID information obtained in the ID calculating unit 135 with an original ID previously stored in the ID setting unit 138. If these IDs coincide with each other, the ID verifying unit 236 generates a timer activation signal and outputs it to the timer unit 240.

Upon receiving the timer activation signal from the ID verifying unit 236, the timer unit 240 starts counting time, and when the time is beyond the predetermined time, it outputs a warning signal. The timer unit 240 functions as a measuring unit measuring a time interval during which second and third signals are received.

The judgment unit 239 judges a presence/absence of the warning signal from the timer unit 240, and when no warning signal exists, it outputs a command to a following stage device.

### (Operation of Control System 200)

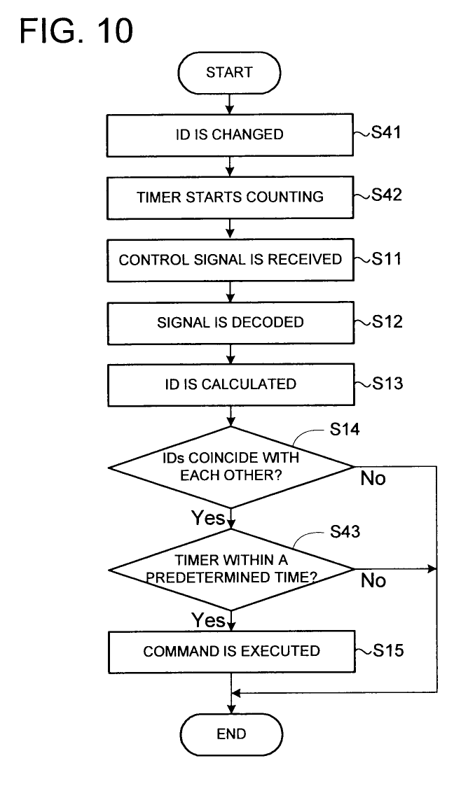

FIG. 10 is a flowchart representing one example of operating procedures of the control system 200. Here, a case is assumed where a device is controlled by a control signal after an ID is changed. In the present embodiment, it is possible to prevent that a third person steals ID information of device to thereby control the device, at the time of update procedure and the like of ID information.

### (1) Change of ID

The ID of device is changed (step S41). For example, it is possible to change the ID of device by following a procedure shown in FIG. 8. Further, in accordance with the change of the ID of device, the counting of time by the timer unit 240 is started (step S42).

### (2) Control of Device

The device is controlled by the control signal. Basically, the device is controlled by a procedure similar to that shown in FIG. 9 (steps S11 through S15). Here, when the control signal is received within a predetermined time after updating the ID, a control command is received and executed (step S43). Meanwhile, when the control signal is not received within the predetermined time, the execution of control command is rejected (step S43). According to the present embodiment, it is possible to prevent the device from being controlled by the third person even if the ID of device is stolen.

### Other Embodiments

Embodiments of the present invention are not limited to the aforementioned embodiments and can be expanded and modified, and the expanded and modified embodiments are also included in the technical scope of the present invention. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A receiving apparatus, comprising:
a receiving unit receiving a plurality of signals in which at least a part of transfer rates is different during a certain period of time;
a rate detecting unit detecting a plurality of transfer rates of the plurality of signals;
a first obtaining unit obtaining first information based on the plurality of transfer rates;
a second obtaining unit obtaining second information based on the plurality of signals; and
a control signal generating unit generating a control signal controlling a device based on the first and second information.

2. The apparatus according to claim 1,
wherein the first information corresponds to an identification which identifies the device.

3. The apparatus according to claim 2,
wherein the receiving unit receives first and second signals being the plurality of signals;
wherein the first obtaining unit obtains third and fourth information respectively corresponding to first and second identifications from the first and second signals; and
wherein the apparatus, further comprising
a changing unit changing an identification of the device from the first identification to the second identification.

4. The apparatus according to claim 3,
wherein the receiving unit further receives a third signals;
wherein the first obtaining unit obtains fifth information corresponding to the second identification from the third signals; and
wherein the apparatus, further comprising
a measuring unit measuring a time interval during which the second and third sets of signals are received,
wherein a generation of control signal by the control signal generating unit is restricted when the time interval is greater than a predetermined time interval.

5. The apparatus according to claim 1,
wherein the second obtaining unit, comprising:
an obtaining part obtaining information from each of the plurality of signals; and
a determination part determining the first information by a majority decision based on the plurality of pieces of information.

6. The apparatus according to claim 1,
wherein the first information is obtained based on a combination of the plurality of transfer rates.

7. The apparatus according to claim 1,
wherein the first information is obtained based on a difference in the plurality of transfer rates.

8. A transmission/reception system, comprising:
a transmitting apparatus transmitting a plurality of signals in which at least a part of transfer rates is different during a certain period of time; and
a receiving apparatus, comprising:
a receiving unit receiving the plurality of signals;
a rate detecting unit detecting a plurality of transfer rates of the plurality of signals;
a first obtaining unit obtaining first information based on the plurality of transfer rates;
a second obtaining unit obtaining second information based on the plurality of signals; and
a control signal generating unit generating a control signal controlling a device based on the first and second information.

9. The system according to claim 8,
wherein the first information corresponds to an identification which identifies the device.

10. The system according to claim 9,
wherein the receiving unit receives first and second signals being the plurality of signals;
wherein the first obtaining unit obtains third and fourth information respectively corresponding to first and second identifications from the first and second signals; and
wherein the system, further comprising
a changing unit changing an identification of the device from the first identification to the second identification.

11. The system according to claim 10,
wherein the receiving unit further receives a third signals;
wherein the first obtaining unit obtains fifth information corresponding to the second identification from the third signals; and
wherein the system, further comprising
a measuring unit measuring a time interval during which the second and third sets of signals are received,
wherein a generation of control signal by the control signal generating unit is restricted when the time interval is greater than a predetermined time interval.

12. The system according to claim 8,
wherein the second obtaining unit, comprising:
an obtaining part obtaining information from each of the plurality of signals; and
a determination part determining the first information by a majority decision based on the plurality of pieces of information.

13. The system according to claim 8,
wherein the first information is obtained based on a combination of the plurality of transfer rates.

14. The system according to claim 8,
wherein the first information is obtained based on a difference in the plurality of transfer rates.

15. A device control method, comprising:
receiving a set of a plurality of signals in which at least a part of transfer rates is different;
detecting a plurality of transfer rates of the plurality of signals;
obtaining first information based on the plurality of transfer rates;
obtaining second information based on the plurality of signals; and
generating a control signal controlling a device based on the first and second information.

16. The method according to claim 15,
wherein the first information corresponds to an identification which identifies the device.

17. The method according to claim 16,
wherein the receiving receives first and second signals being the plurality of signals;
wherein in the obtaining of the first information, third and fourth information respectively corresponding to first and second identifications are obtained from the first and second signals; and
wherein the method, further comprising
changing an identification of the device from the first identification to the second identification.

18. The method according to claim 17,
wherein the receiving further receives a third signals;
wherein in the obtaining of the first information, fifth information corresponding to the second identification is obtained from the third signals; and
wherein the method, further comprising
measuring a time interval during which the second and third sets of signals are received,
wherein the generating of control signal is restricted when the time interval is greater than a predetermined time interval.

19. The method according to claim 15,
wherein the obtaining of the second information, comprising:
obtaining information from each of the plurality of signals; and
determining the first information by a majority decision based on the plurality of pieces of information.

20. The method according to claim 15,
wherein the first information is obtained based on a combination of the plurality of transfer rates.
